(19) United States
(12) Patent Application Publication
(10) Pub. No.: US 2005/0251300 A1
(43) Pub. Date: Nov. 10, 2005

(54) Data acquisition system for a vessel

(76) Inventor: Stein Hellvik, Kristiansand (NO)

Correspondence Address: CHRISTIAN D. ABEL, ONSAGERS AS, POSTBOKS 6963 ST. OLAVS PLASS, NORWAY, N-0130, NO

(21) Appl. No.: 10/498,879

(22) PCT Filed: Dec. 20, 2002
(86) PCT No.: PCT/NO02/00492

§ 371 Date: Jun. 22, 2005

(30) Foreign Application Priority Data
Dec. 20, 2001 (NO) 20016285

(51) Int. Cl. G06F 17/00

(52) U.S. Cl. 701/21; 701/35

(57) ABSTRACT

The invention relates to a data acquisition system for use on board a vessel or installation in order to provide basis data concerning the individual hull's response to the individual wave in order to provide an early warning of the risk of waves, which may cause water to wash over the deck of the vessel, resulting in damage to deck equipment, the hull and/or cargo, and which may cause powerful impacts against the bottom of the hull.

### INTRODUCTION

The present invention relates to a data acquisition system for use on board a vessel or an installation, in order to provide basis data regarding hull-influenced waves. The term “hull-influenced waves” refers to waves that alter their behaviour due to the presence of the hull.

In this description the invention will be illustrated by the use of a vessel in which the system according to the invention is used, but it is entirely possible to employ it on other marine installations such as oil platforms, etc.

Basis data for individual waves are provided by means of at least one pressure sensor, which is placed on the hull, i.e. the height of the water above the point where the sensor is located is measured by measuring pressure. Several sensors placed at various points on the hull may be employed if so desired in order to measure the different water heights established by an individual wave on the hull. An accurate specification of the location of the sensors in relation to the hull also represents vital basis data, since this will be particularly important for the assessment of the overall picture.

The basis data for individual waves are used in order to set up a diagram of hull-influenced waves or “resultant wave diagram” for the individual hull (i.e. the curve traced by the individual wave on the individual hull's sides). The hull-influenced wave diagram will form the basis for setting up a projection diagram, which means that based on the waves' characteristics (or the behaviour of the sea) in a specific period of time it will be possible to derive future characteristics for the waves (or sea behaviour) in order to predict a development and provide an early warning of the risk of the occurrence of waves that are of such a nature that they may cause so-called “green sea” on deck. “Green sea” is a term employed for the situation where water washes over the vessel's deck in such quantities and at such a speed that it represents a risk of physical damage to deck equipment, deck cargo or/and the hull's integrity (development in distance between the hull's deck and the crest of the wave). Online presentation on board of the height of individual waves on the hull, of “hull-influenced or resultant wave diagram” and “hull-influenced or resultant wave diagram projection” with continuous updating of the information are provided by means of the invention.

The diagrams, i.e. the said “resultant wave diagram” and “resultant wave diagram projection” are used in order to predict a development and provide early warning of the risk of conditions where large waves may result in powerful impacts against the bottom of the hull (development in distance between the bottom of the hull and the trough of the wave). This phenomenon will hereinafter be called “bottom slamming”, resulting in powerful vibrations and thereby a substantial reduction in the hull's fatigue capacity (service life).

The said “green sea” on deck and bottom slamming are caused mainly by particularly high individual waves, hereinafter called “peak waves”.

The basis data may also be used for calculating wave direction relative to the hull, information that is important for optimal navigation in bad weather.

Rough seas with heavy sea spray and a long distance from bridge to bow make it impossible to establish wave direction visually from the ship's bridge, particularly at night. Deck cargo (containers, etc.) impede the view from bridge to the bow area and may also result in a blind zone of several hundred metres in front of the ship's bow.

The basis data together with information from other systems such as the ship's speed, accelerations and inclinations, may be employed in order to establish “sea state”, the actual wave pattern without influence from the hull, provided the hull's design (flare) does not have too great an influence on the waves, by measurements of the ship's half-length or these can be compared with measurements in the bow area and/or aft.

The above means that when pressure is measured at the ship's half-length and the hull is such that its influence on the wave pattern is not significant, a “sea state” diagram can be produced that may be used for other vessels.

By integrating data for fuel consumption for main machinery in the processing of the basis data, it will be possible to optimise fuel consumption by means of the ship's course and speed.

By means of expert systems and historical basis data and data from integrated systems, including fuel consumption and GPS, it will be possible to calculate and recommend optimal operational parameters; course, speed, also within specific geographical areas with special weather and wave conditions.

By means of expert systems and historical basis data and data from integrated systems, including fuel consumption and GPS, it will be possible to develop a simulator in order to arrive at general optimal operational parameters in different weather and wave conditions.

### BACKGROUND

Ever since people began to build vessels, “green sea” on deck has represented a threat to the hull's integrity, the vessel's cargo, the safety of the people on board, the environment and other values. Even in our time “green sea” on deck results in damage and total loss.

The forces in waves can be enormous, on account of both weight and velocity. The wave pattern is typically fairly uniform, but with considerably larger individual waves, so-called peak waves. It is these peak waves in particular that cause damage. The weight of water washing over the deck represents a risk of collapse of the hull. Weight combined with velocity represent a risk to deck equipment and deck cargo. No system exists at present, which, based on direct measurements of the height of individual waves on individual hulls, provides a warning of “green sea” or bottom slamming (i.e. impact of waves against the ship's bottom) particularly from peak waves.

Different types of ship have varying degrees of vulnerability to green sea on deck. Tankers are relatively immune to damage to deck equipment; here it is the weight of green sea on deck and bottom slamming that represent the greatest risk with regard to safety and damage. For other “lighter” and often faster ships, such as container ships, it is damage to deck equipment and deck cargo together with bottom slamming that represent the greatest risk with regard to safety and damage. For all ships operating near the limit for “green sea”, a change of course towards the wave direction without a reduction in speed will also substantially increase the stresses and risk of “green sea” and bottom slamming.

The trend has been and appears to be continuing to move in the direction of ever larger, faster and lighter hulls for economic optimisation. Strength margins in hull designs are continuously under pressure. On board the requirement is increasing for optimal economic operation.

For economic reasons it will be desirable to be able to operate as close as possible to the limits for green sea and bottom slamming in bad weather.

The crew on board do their best, but lack of information leads to decisions on optimal course, speed ballast and trim still being based on individual evaluations. With such a development, there is clearly a necessity for replacing individual evaluations with objective information based on measurements.

There is therefore an increasing need to provide systems that can supply reliable information for optimal economic operation. Unfortunately, the interest in pure safety systems, which are not mandatory or required by law, is insignificant. Safety therefore has to be built into systems that have a positive economic utilitarian value that can be documented within 3 years. Reduction in the amount of damage to cargo, reduction in the amount of bottom slamming and reduction in fuel consumption can represent such measurable parameters.

Prior art technology for providing information on waves includes various wave radar systems. However, low updating frequency has been a problem when it comes to detecting peak waves. Furthermore, they may also have problems in bad weather due to sea spray and snow, etc. which affect reflecting signals. Data from such wave radar systems have been used to establish “sea state” (the wave spectrum). “Sea state” is used as input in calculation models for calculating the ship's tolerance limits for “green sea”. These calculations can then be made available in table format to the people on board. Wave radar is installed on board or in buoys deployed in individual areas. The drawback with such systems, in addition to varying experiences with the accuracy of wave radar data (peak waves and bad weather), is that they employ calculation models with many variable factors and many assumptions and not real data related to the influence of the waves on the individual hull.

Direct measurements regarding the individual hull's response to each individual wave based on the hull's actual speed and course (distance hull's deck/wave crest and distance hull's bottom/wave trough) will form a better basis for providing the people on board with early warning of risk of “green sea” on deck and of bottom slamming together with wave direction. The people on board can then also keep up with the actual development. Complicated calculation models adapted to the individual hulls will no longer be necessary.

It is previously known to mount pressure sensors on a ship's hull under the waterline with the object of calculating a static value that is as accurate as possible (e.g. by reading off the pressure from a derived water column in a riser) of the water height outside in order to establish the ship's draught during loading and unloading operations. On both the sensor and data processing sides, these systems are adapted for removing components of short duration, as in the case of waves. Mapping of wave patterns requires completely different equipment and processing methods. In the data acquisition system in question it is the dynamic values that are interesting.

It is previously known to mount pressure sensors on a ship's hull, with the objective of calculating a derived quantity from the sensor signals. A solution of this kind is disclosed in GB-2 278 446. In this case, however, the sensors are located below the waterline, at the bottom of the ship's sides along the whole hull, and not specifically in the bow area. Nor is information derived concerning the waves, and particularly not with a view to detection of waves that may lead to “green sea”, but on the contrary information is derived concerning the influence of stress on the hull.

The Data Acquisition System—the Object

The object of the data acquisition system according to the invention is to provide on board a vessel or floating installation:
a) Basis data for each wave (water height in the form of pressure) that strikes the vessel/installation for continuous presentation on board of the hull's response to the waves.
b) Basis data (pressure, sensor location) for calculating the waves' direction relative to the hull.
c) Historical basis data for setting up the individual hull's “resultant wave diagram” in order inter alia to set up a “resultant wave diagram projection” or “wave projection”, and use thereof for providing early warning of the risk that limit values for green sea and/or bottom slamming on deck may be exceeded.
d) Indication or specification of wave direction. Wave direction is calculated initially in relation to the ship's longitudinal axis and may subsequently be calculated in degrees. Calculation of the wave direction is described below.
e) Establishment of alarm limits for the ship's inclination in both axes on the basis of inclinometer measurements. These are defined in relation to the vessel's safety and tolerance of stability/damage to cargo.
f) Establishment of limit values for actions; change of course, speed, ballast and trim decided by the operator.
g) Establishment of alarm limits for accelerations in both axes on the basis of accelerometer measurements. These are defined in relation to the vessel's safety and tolerance of stability/damage to cargo. Establishment of limit values for actions; change of course, speed, ballast and trim decided by the operator.
h) Advice on initiation of measures for preventing the said limit values from being exceeded.
i) Advice on optimal operational parameters may comprise speed, course, ballast and trim condition. The basis for such advice may also be based on historical integrated data that may include data for accelerations, inclinations and position. The basis for optimal economic operational parameters may also include historical integrated data concerning fuel consumption for main machinery.
j) A simulation model together with the use thereof for displaying the consequences different operational decisions will have under different weather and wave conditions.
   Data Acquisition System—Components

The said objects are achieved with a data acquisition system as set forth in the introduction, characterised in that it comprises
at least one sensor device for mounting on the vessel's hull, usually in an area near the bow, arranged to provide a measuring signal associated with the presence of water at a given detection height on the outside of the hull,
a data processing unit arranged for storing and processing the measuring signals, and
signal transmission means for transmitting measuring signals to the data processing unit for storing and processing values for the measuring signals.

The data acquisition system also comprises:

A) One or more sensor devices for mounting on the vessel's/installation's hull, arranged to provide a measuring signal associated with the presence of water on the outside of the hull, where the sensor device(s) will preferably consist of at least two pressure sensors mounted at different heights in the same longitudinal direction and on the same side of the hull. A sensor device with only one sensor is not to be recommended since the dynamic in the waves and thereby the basis data from only one sensor may vary with the wave pattern and fail to provide the desired accuracy in the final result. The number of sensor devices will be capable of being varied according to the hull design, sailing pattern and weather conditions within the sailing areas concerned as well as to the user's requirements for accuracy in the final result and any future regulations. Examples of variations are:
FPSO/FSO (Floating Production, Storage and Offloading/Floating, Storage and Offloading) with cylindrical bow remaining stationary in the same position with the bow into the waves—continuous loading/unloading of oil.
Container ship with cruiser bow (narrow bow, cuts the waves), highest possible speed (approximately 25 knots or more) even in bad weather.

With the same sea state and the same speed, course and loading condition, the hull-influenced wave diagram may vary greatly with hull design. This should therefore be taken into account when deciding the number of sensor devices and their installation in the individual hull.

With regard to the number and location of sensor devices the following alternatives will be relevant:
a) One sensor device on each side of the hull's bow. This will be a reasonable solution since experience shows that the bow is most exposed to “green sea” on deck and to bottom slamming.
b) One sensor device on each side at the hull's half-length. Like a), but on the half-length since it is assumed that the wave turbulence will be substantially less in this region, particularly in the case of special designs of the hull in the bow. For hulls with a narrow bow (little distance between the sensor devices), the sensor devices on the half-length (considerably greater distance) will provide a more accurate measurement of the wave direction.
c) One sensor device on each side of the hull's bow plus one sensor device on each side at the hull's half-length. A natural extension of a) and b) with increased accuracy.
d) One sensor device on each side of the hull's bow plus one sensor device on each side at the hull's half-length plus one sensor device on each side at the stern of the hull. This will be an approximately complete number for most types of hull. Probably unsuitable for stationary hulls such as FSO/FPSO with waves constantly against the bow. Suitable for hulls that experience heavy waves into the stern.

With the number of sensor devices indicated in c) and d), in many cases it will be possible to have 2 sets of sensor devices (in parallel on each side of the hull) with 2 sensors, while the remaining sensors may consist of only one sensor depending on the requirement for accuracy in the measurements.

The individual sensor device will typically but not in a limiting manner consist of:
a) one or more pressure sensors
b) riser with flange and valve in a preferred embodiment of the invention
c) valve with flange
d) sleeve device or grommet
e) outer pipe with flange

a) The pressure sensor may be of a standard make; electronic, ceramic, fibre optic or other type that can detect high water and air pressure. For sensors without automatic calibration for the outside air pressure, the sensor for measuring the outside air pressure in particular must be installed for calibration of the basis data. A pressure sensor is mounted on a flange of a riser with a flange. When using several sensors in a sensor device all the pressure sensors can be connected to the same riser, where a valve is preferably mounted for each sensor between sensor and riser for control of purging and cleaning, e.g. when carrying out high-pressure hosing for the removal of foreign bodies and mud.

b) Riser with flange and valve. If so desired, the riser will be able to reach the hull's deck and be equipped with a mechanically or remotely controlled valve. The riser will not influence the basis data since the valve, which is preferably mounted at the very bottom of the riser, will be closed during operation. Through the valve it will be possible to remove automatically or manually “air cushions”, which may become established in the system. These air cushions will influence the sensor's basis data. In addition it will be possible to use the riser for high-pressure hosing of the system for the removal of any foreign bodies and sediment. The riser is mounted on a flange on a valve with a flange. The riser is a practical arrangement, but the object, purging and cleaning, may also be accomplished by means of other solutions.

c) Valve with flange. In many cases this will be obligatory for safety reasons in order to be able to cut off any water penetration. The valve also enables maintenance, repairs and replacement of a) and b) above to be carried out. Depending on the regulations valid at any time, it will be possible to derive many variants/combinations of b) and c). From the point of view of pure measurement technique, it will be possible to omit b), d) and in many cases e), or replace them with a different purging arrangement for the system. A valve is mounted on the flange on a sleeve device or grommet.

d) Design of sleeve device or grommet (internal and external hull reinforcement) will be according to legal requirements and regulations.

e) A short pipe/flange will preferably be mounted on the sleeve device or grommet on the outside of the hull to prevent penetration of foreign bodies into the system. It should be pliable (semicircle) in order to avoid physical damage from foreign bodies and reduce turbulence in the water. The pipe/flange will typically be mounted vertically on the ship's side, but may also be mounted tilted slightly in the hull's longitudinal direction.

In the present description the expression “the sensors' height position” refers to the position in height relative to the bottom of the hull, while “longitudinal position” refers to the position along the vessel's longitudinal axis. The optimal height and longitudinal positions in turn will be dependent on the design of the hull, and in special cases may be different on the port and starboard sides. Alternatively, an even larger number of sensor devices may be employed in order to provide an even more detailed basis.

In each sensor device a sensor (hereinafter called S1) is mounted preferably near the bottom of the hull in order to provide continuously dynamic basis data on each wave that passes the hull (height of water column). The location near the bottom of the ship will provide the most accurate basis data related to “bottom slamming”. Locating S1 in this way will reduce the penetration of air(bubbles) that form an air cushion in front of S1. The advantage of using water pressure compared with the use of air pressure will be that while the air forms a “cushion” that can be compressed, producing inertia in the system and introducing inaccuracy, the water will transfer the pressure directly. As mentioned above, such air cushions can be removed by purging the system manually or automatically.

A second sensor (hereinafter called S2) will preferably be mounted at a desired height between the hull's draught in loaded condition and the hull's deck. The dynamic and turbulence in the waves may vary greatly with wave heights/spectra. The water column over the sensors will also be influenced by the hull's design and speed. The height position for sensor S2 will therefore be an expression of when (at which wave heights on the hull) it is desirable to calibrate the basis data in sensor S1 for such dynamic and turbulence in the waves when setting up the “resultant wave diagram” (amplitudes and frequencies) for the individual hull and the derived “wave response projection”. The exact distance between S1 and S2 will thus be known. S2 will produce basis data in the presence of water.

By providing an additional sensor (hereinafter called S3) in a second embodiment of the invention in the same longitudinal position as S1 and S2, but on a level with the hull's deck, this sensor will also be a calibrator for S1 for an even more accurate water height and a direct alarm level for “green sea” on deck.

S1 may be mounted higher on the hull, even above the waterline. S1 may be calibrated for the effect of the “air cushion” that is produced. The air cushion may be removed or reduced by a valve near the sleeve device or grommet and/or by mounting S1 in a position lower than the sleeve device or grommet. Such a position, however, may lead to reduced accuracy in the basis data, particularly with regard to “bottom slamming”.

It will be possible to omit S2 in all sensor devices if greater uncertainty and possibly inaccuracy in the basis data are accepted.

B) A data acquisition and processing unit arranged for storing and processing the measuring signals. In a special embodiment the data acquisition and processing unit is arranged for processing measuring data from the sensor devices that detect a development in the wave pattern, which may/will lead to “green sea” and/or bottom slamming and/or wave direction. The data acquisition and processing unit may be located in the forepeak or on the ship's bridge. When located, e.g., on the ship's bridge, the data acquisition and processing unit may be connected to a processing and presentation unit for receiving and displaying the total data signal.

In this case the processing and presentation unit will advantageously comprise means for processing the total data signal in order to provide, i.e. to reconstruct, data corresponding to the measuring data from the sensor devices. On the basis of these data a wave diagram is also provided, which is projected in time in order to predict waves, which may cause water to wash over the deck of the vessel and which may result in bottom slamming. For this purpose data may also be employed from an inclinometer or accelerometer together with data concerning the ship's course, speed, loading and ballast condition and position, which data are supplied to the data acquisition and processing unit and subsequently to the processing and presentation unit.

In a special embodiment the data acquisition system also comprises one or more inclinometers, 2 axes and/or one or more accelerometers, 2 axes, for installation in the vessel, preferably with one set in the vessel's forepeak. These can provide static and/or dynamic data associated with the vessel's roll, heave and accelerations. These data can also be used separately or together with measurements from the pressure sensors, and possibly also with other integrated data.

In a preferred embodiment of the invention, the data processing unit in the data acquisition system according to the invention comprises means for: a) processing the data from the sensor device(s) mounted preferably near the ship's bottom in order to provide wave height signals (wave spectrum) as a function of time, b) recording data concerning the vessel's course, speed, loading condition, trim and position and processing thereof in order to provide the vessel's response profile regarding each individual wave in the geographical area concerned as a function of time, c) on the basis of the wave height signals provided in step a) together with the profile provided in step b), establishing the individual wave response for each wave with hull influence, collected in series in a “resultant wave diagram” for predicting “hull-influenced wave pattern” in time and/or the vessel's condition as a consequence of this development in a “resultant wave diagram projection”, d) providing limit values for wave heights at the sensor devices as a function of the vessel's capacitive load levels, i.e. those levels the structure has the capacity to tolerate (or by the possible introduction of obligatory, permitted load levels), e) on the basis of input data concerning limit values for wave height corresponding to green sea and bottom slamming providing limit values for wave height together with alarm functions in the event of the limit value being exceeded, f) on the basis of input data at a) to e) above, providing limit values for preventive actions, such as changing course, speed, ballast and trim, the limit values being adapted at all times to the vessel's condition, the height of the waves and the predicted development, g) storing the signals provided in steps a)-f) for subsequent processing and compilation of statistics.

Historical data, including that from integrated systems, may be employed by means of expert systems for establishing an empirical basis for advising on optimal operational parameters. The system will thereby “remember” previous events also related to limited geographical areas. By letting the vessel undergo operational test programs (gradual changes in speed/course in different loading and trim conditions, in different weather and wave conditions and possibly in different geographical areas), an empirical base can be established at an early stage.

By employing the said empirical base it will also be possible to establish a simulation model for displaying consequences of operational decisions.

By integrating data on the main machinery's fuel consumption and utilisation factor in the empirical base and the simulation module, it will be possible to give advice and simulate not only optimal operational parameters with regard to safety, but also with regard to economy. Experience shows that in given circumstances and weather conditions an increase in speed may result in lower fuel consumption for the main machinery.

As mentioned previously, the data processing unit will advantageously comprise means for: a) calibration of each sensor S1 mounted nearest the vessel's bottom, by means of the measuring data from a sensor mounted in the same longitudinal position, but at a different height to the sensor near the vessel's bottom, S2, to avoid wrong measurements in the event of dynamic and turbulence in the waves, and b) comparison of the measuring data from the various sensor devices and filtering in order to obtain a high degree of accuracy.

With regard to the establishment of the wave direction, the data processing unit in the system according to the invention will further comprise means for calculating wave direction in relation to the vessel's longitudinal axis based on:

a) comparison of maximum values in each individual wave, preferably provided in continuously updated series for increased accuracy, from several sensor devices located in the same longitudinal position and height, but on opposite sides of the vessel, where the signals are preferably corrected for inclination, acceleration and possibly also the vessel's speed before the comparison, and

b) comparison of the time lapse for maximum values in each individual wave, preferably provided in continuously updated series for increased accuracy, from sensor devices located in the same longitudinal position and height, but on opposite sides of the vessel, in order to establish the time difference between registering the wave crests, preferably corrected for inclination, acceleration and the vessel's speed before the comparison, in order thereby to be able to calculate the relationship between the vessel's longitudinal direction and the wave front's direction. The distance between the sensors is known. The time difference between the wave crests' passing of each sensor is known. The distance the wave crest moves in the course of the time difference is calculated. The waves' angle to the hull is calculated. Series of measurements give a more accurate result.

An important part of the data acquisition system according to the invention is a presentation unit connected to the data processing unit for displaying the output signals from the data processing unit. In a preferred embodiment the presentation unit comprises means for displaying continuously updated data for:

a) Status: wave height and values in relation to action limits and alarm levels for:—“green sea”—bottom slamming—inclination—acceleration—plus wave direction. Information on the parameters is updated and presented online. To permit the effect of (preventive) actions to be seen quickly, the data are also presented historically, e.g. for an hour or half an hour ago.

b) Operational data: speed—course—fuel consumption for main machinery. Information on the parameters is updated and presented online. To permit the effect of (preventive) actions to be seen quickly, the data are also presented historically, e.g. for an hour or half an hour ago. In a special embodiment advice is also presented for optimal operational parameters based on historical data and the use of expert systems. Such advice may also take into account special weather/wave conditions in geographically specific areas.

c) Other data: loading condition—trim—wind force/direction—position. These may be retrieved (together with said speed, course and fuel consumption) and presented.

d) Warning status: based on the previously mentioned “resultant wave diagram” and “resultant wave diagram projection”, an early warning may be presented concerning the risk that specific limit levels for actions and for alarm may be exceeded. Time indication or specification this exceeding of limits will also be presented. The system, “the resultant wave diagram projection”, will quickly detect and adjust for changes in the weather development and for changes in operational parameters (speed/course).

e) Alarm status: since the presentation unit is arranged to display the data in a), b) and c) in real time, an alarm will be triggered when limit levels for action alarm and for capacitive levels are exceeded. Alarms may be activated audibly or visually. The system may require alarms to be acknowledged. In an even more preferred embodiment the presentation unit is also arranged to recommend preventive actions.

A particularly comprehensive data presentation is described in the above. The data presentation may be simplified/reduced to a warning on alarm levels. With reference to previously mentioned application, the data presentation may also include presentation of advice and simulations.

C) Signal transmission means for transmitting measuring signals to the data processing unit. These comprise electric or fibre optic cables. Fibre optic cables will be preferable on account of their service life, EX immunity and immunity to electromagnetic noise. Signal transmission may also be performed via radio link.

The invention will now be described in greater detail by means of the attached drawing in which:

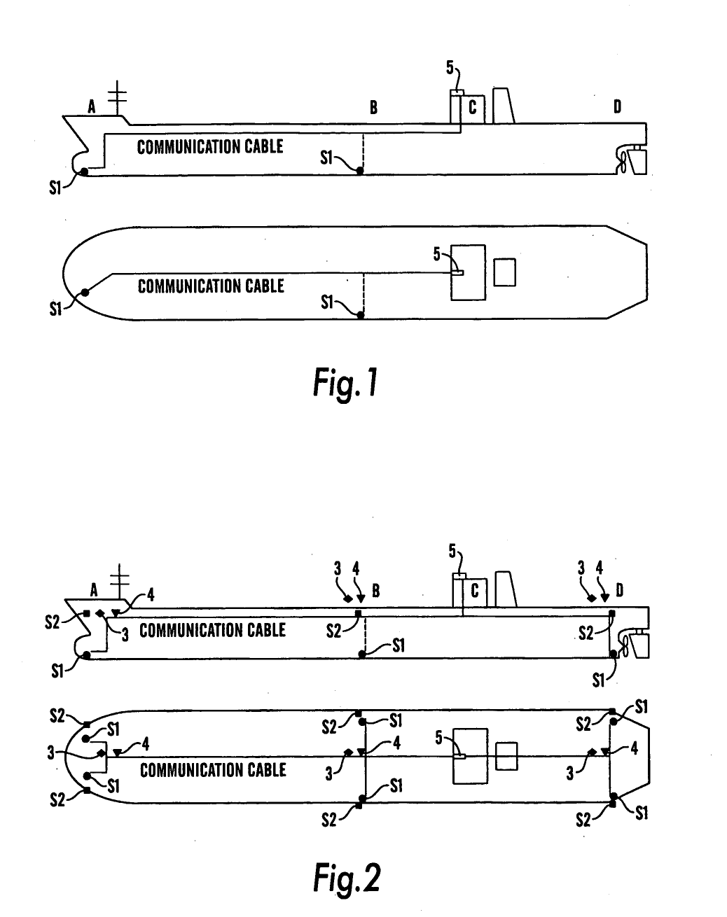

FIGS. 1 and 2 illustrate a vessel provided with a data acquisition system according to the invention,

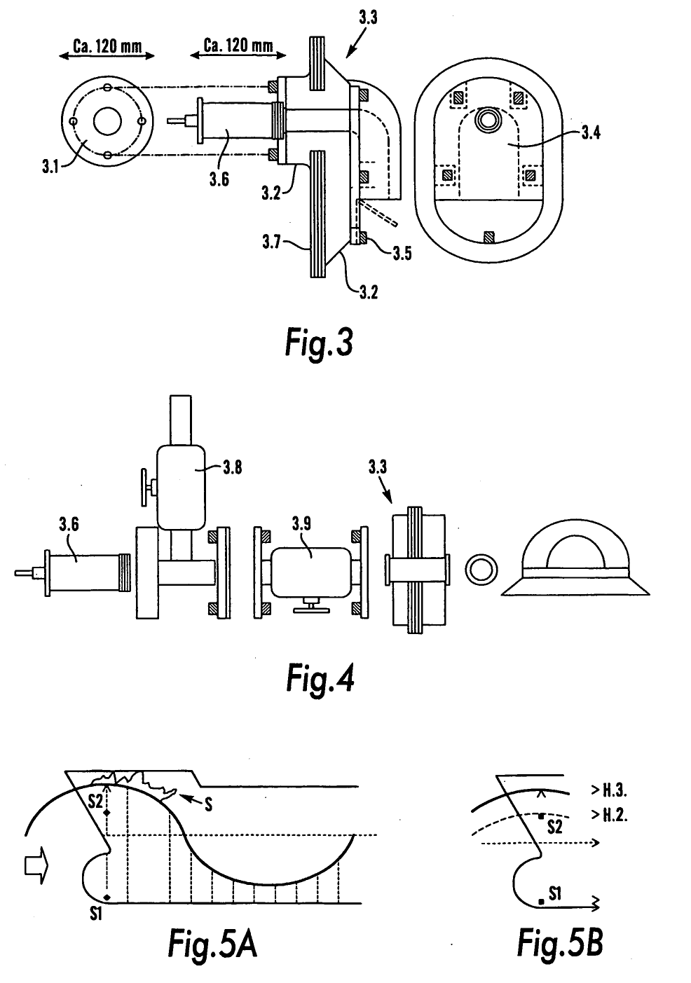

FIGS. 3 and 4 illustrate an embodiment of the sensor device,

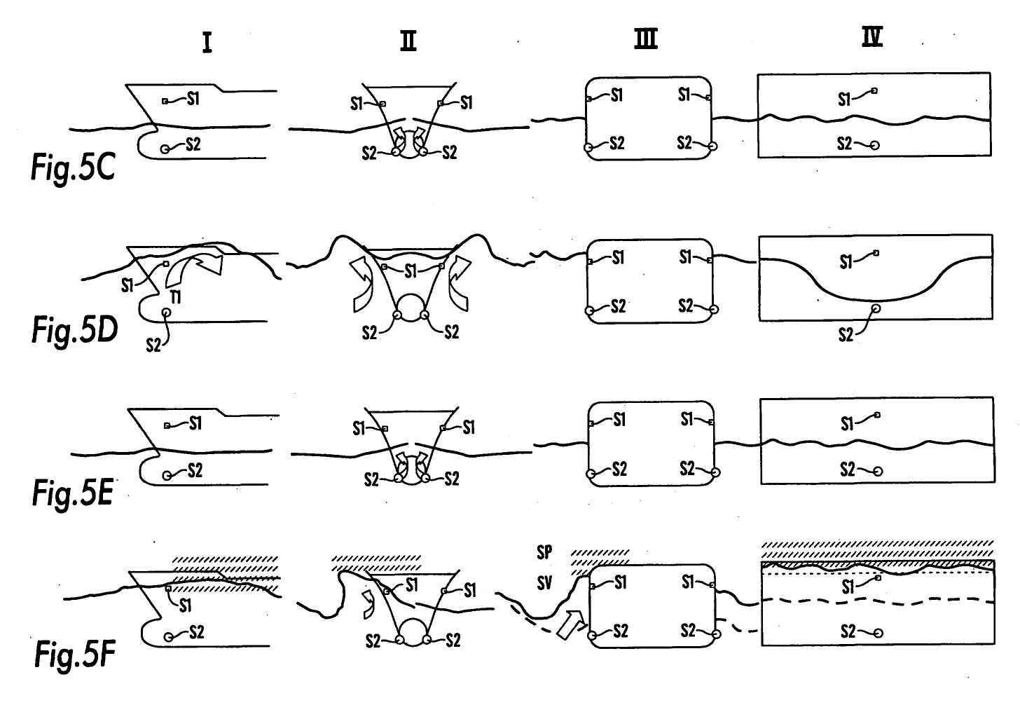

FIG. 5 illustrates wave height conditions in relation to sensor location,

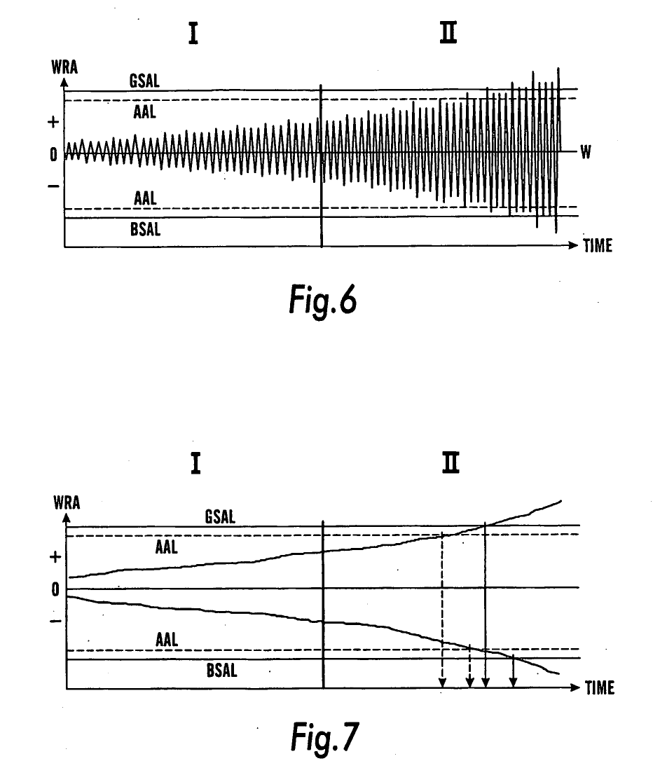

FIG. 6 illustrates a “resultant wave diagram” and a “wave response projection”,

FIG. 7 illustrates a “resultant wave diagram” and a “wave response projection” only for wave crests and wave troughs,

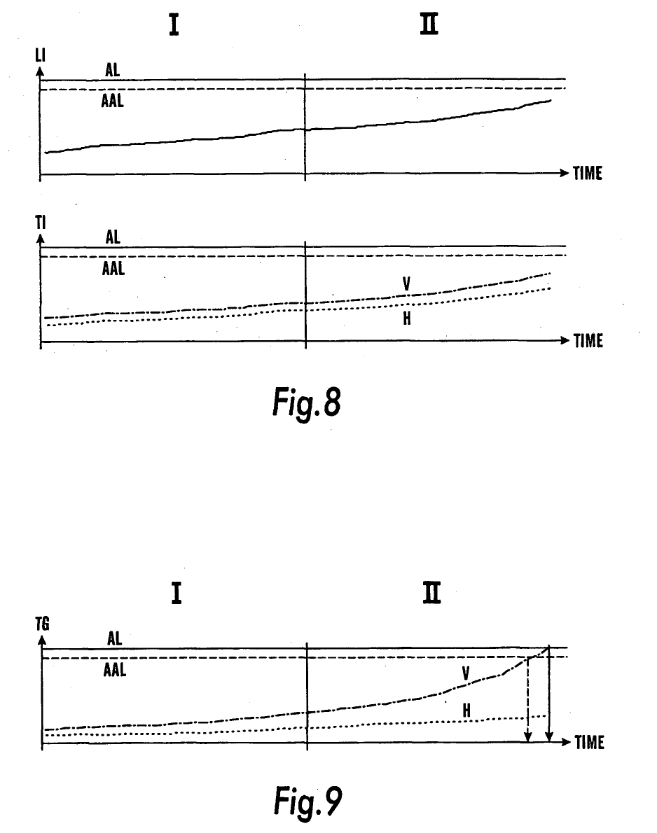

FIG. 8 illustrates a time lapse diagram and a projection for inclination in both planes (fore-and-aft and thwartship) with alarm limits,

FIG. 9 illustrates a corresponding diagram and a projection for acceleration,

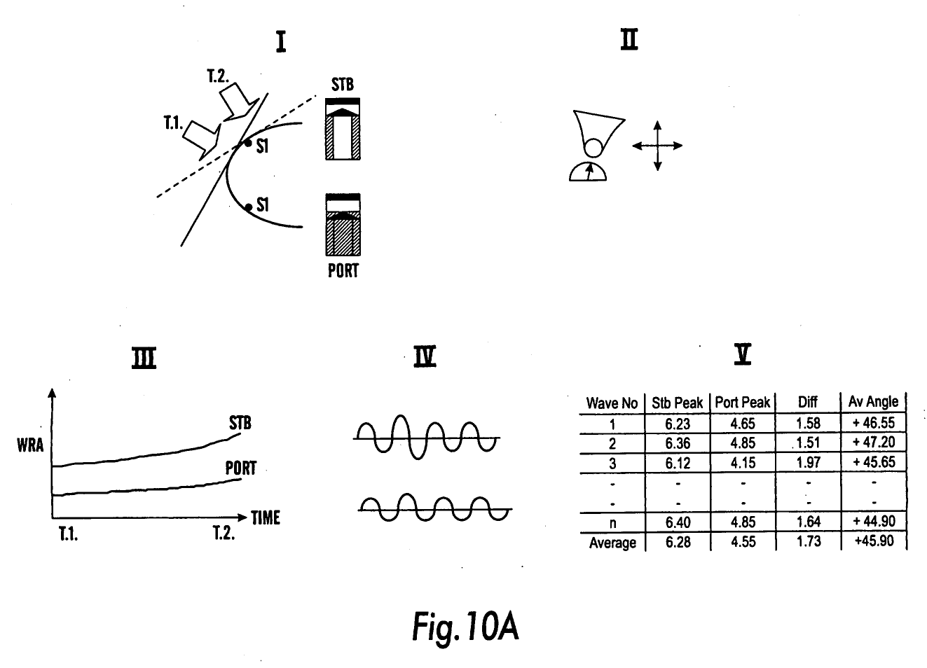

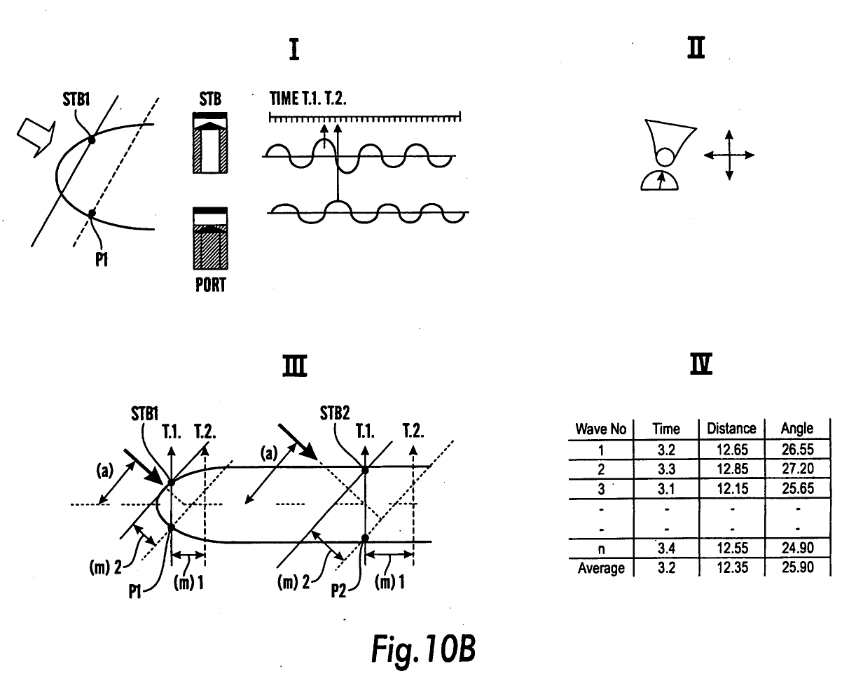

FIG. 10 illustrates the calculation of wave direction,

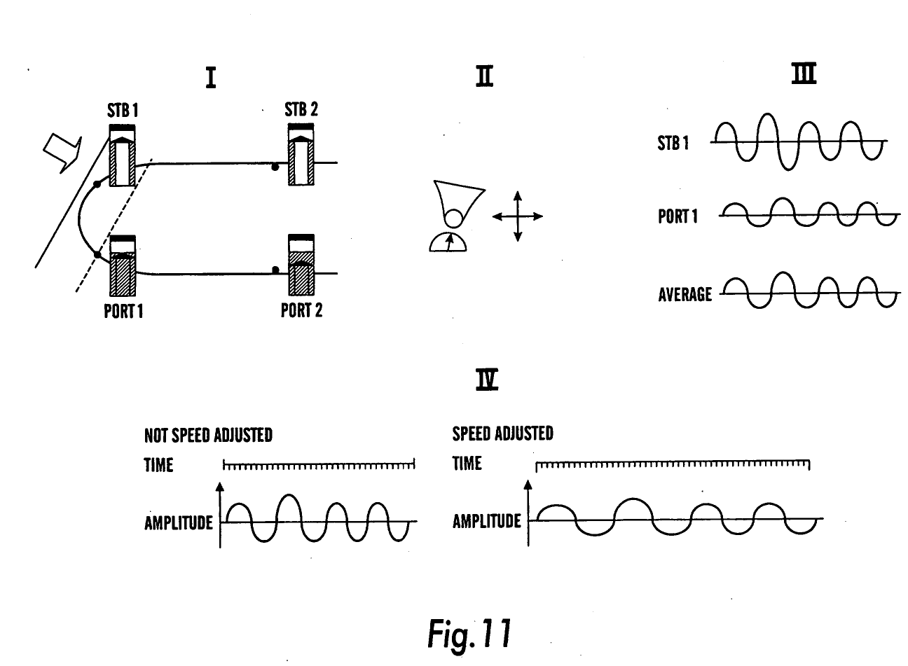

FIG. 11 illustrates how the system can be employed for calculating actual “sea state”,

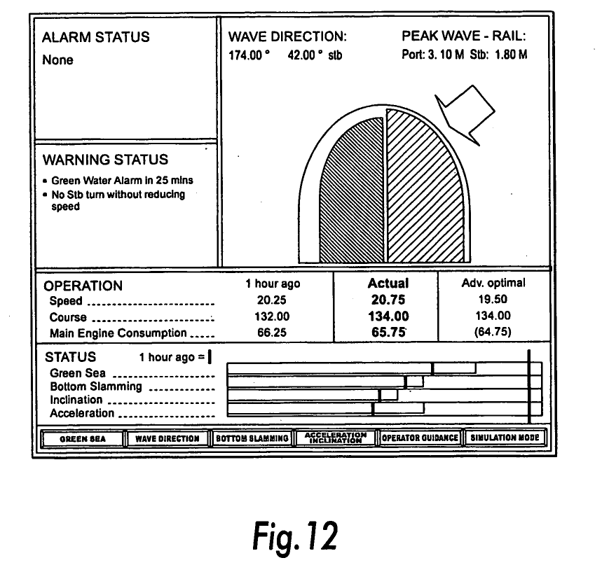

FIG. 12 illustrates an example of a display in the presentation unit.

FIG. 1 is a view of a vessel provided with a data acquisition system according to a simplest possible embodiment of the invention; a pressure sensor S1 in the vessel's forepeak A or a pressure sensor at the vessel's half-length B. In the same figure C indicates the vessel's bridge and D the stern. The reference numeral 5 refers to the data processing and presentation unit. In an exceptionally simple version, the sensor S1 may be moved to the vessel's rail to provide a direct alarm for “green sea” on deck. This location, however, will not provide information related to bottom slamming.

FIG. 2 is a view of a vessel provided with a data acquisition system of a comprehensive nature. The system comprises a pressure sensor S1, a calibration sensor S2, accelerometers 3, inclinometers 4 and a data processing and presentation unit 5. The data acquisition system may include any combination within FIG. 2 with possible additional extensions.

FIG. 3 illustrates how a pressure sensor with attachment arrangement, sleeve device or grommet and external pipe can be installed. The pipe may be designed in various ways. In the figure, 3.1 indicates a flange, 3.6 indicates the actual sensor, 3.2 indicates seals, 3.7 indicates the vessel's hull, 3.5 indicates a cover, 3.3 indicates a sleeve device or grommet and 3.4 indicates an external pipe flange.

FIG. 4 illustrates how a valve 3.9 and a riser 3.8 with valve can be installed in the sensor arrangement. In many cases the valve 3.9 will be obligatory for reasons of safety, particularly when mounted at/below the waterline. With the valve 3.9 the system can be shut down and maintenance/repairs/replacements carried out. With a riser installed the system can be purged with the riser's valve (manually or remotely controlled opening/closing mechanism) in order to remove any air cushions between sensor 3.6 and the water outside. The air cushion gives rise to inertia in the measurements. Through the riser 3.8 the system can also be high-pressure hosed in order to remove any foreign bodies or mud. The riser 3.8 is a practical arrangement, but the object, purging and cleaning, may also be achieved with other solutions.

FIG. 5 illustrates as already mentioned wave height conditions in relation to sensor location.

FIG. 5A illustrates how the sensor S1 continuously detects water heights above the sensor when a wave passes and how a wave pattern is established with wave crest and wave trough. The wave is illustrated by an unbroken line (sinusoidal) while the waterline (waterline—still water) is illustrated by a dotted line. The figure also shows sea spray S. The height reached by the wave crest on the individual hull can be derived and related to the risk of “green sea” on deck. The height reached by the wave trough over the bottom of the individual hull can be derived and related to the risk of bottom slamming.

FIG. 5B illustrates how the values in S1 can be calibrated at the moment when S2 detects water. H3 is the value for the peak wave, H2 corresponds to the position of the calibration sensor S2, the dotted line indicates the water level for still water, H1 shows the position of the pressure sensor S1 and H0 the position of the bottom of the vessel. At this moment the exact height between S1 and S2 can be established. The calibration values used for lower wave heights can be entered manually based on practical experience, etc. or by means of model experiments. On account of the “air cushion” in the measuring system in S2, S1 and S2 will provide different signals on detection of water even in S2. The degree of increasing or decreasing differences in the values in S1 and S2 will be an expression of increasing/decreasing dynamic/turbulence in the upper layer of the wave and together with time frequencies for these can be included in the measuring system.

In a special embodiment possibly with special hull designs, a sensor may also be mounted at the hull's rail for issuing a direct alarm for “green sea” on deck.

FIGS. 5C-F illustrate how the hull influences the wave pattern. More specifically, the figure illustrates the wave influence from in front/from the side without taking account of accelerations/inclinations. The figure illustrates how upwardly moving and downwardly moving currents/turbulence influence sensor data in high waves.

The figures illustrate in column I the forepeak from the side, in column II the forepeak from in front, in column III the half-length in section and in column IV the half-length from the side.

FIG. 5C illustrates the situation with calm sea in the opposite direction relative to the vessel. In column I it can be seen that the upper sensor S1 is located above the waterline while the lower sensor II is located below the waterline. In column II it can be seen that turbulence occurs round the bow (indicated by the arrows). In columns III and IV we see that at the vessel's half-length S1 is still above water and S2 under water.

FIG. 5D illustrates the situation with rough sea in the opposite direction relative to the vessel. Column I shows that both S1 and S2 are now located under water, the arrow indicating turbulence in the wave. The turbulence is also illustrated in column II. Columns III and IV show that the sensor S1 is located above water at the half-length, while S2 is located under water.

FIG. 5E illustrates the situation with calm sea against one side of the vessel. The sensor S1 is located above the water level in all the columns, while S2 is located under water. Column II shows turbulence indicated by arrows.

FIG. 5F illustrates the situation with rough sea against one side of the vessel. In column I we see that on one side of the forepeak S1 is located under water, while column II shows that on the other side S1 is located above water. Column II also illustrates turbulence in the wave indicated by arrows. Columns III and IV show spray SP and swell SV, and in these columns S1 is shown under water on one side and above water on the other. The diagonal lines indicate spray. The dotted lines depict the green sea wave after filtering of spray and “run-ups”.

FIG. 6 illustrates a “resultant wave diagram” in part I (diagram for the last minutes measured) and a “wave response projection” in part II (diagram for the “next” minutes). GSAL stands for “Green Sea Alarm Level” and illustrates the level that has to be exceeded in order to trigger a Green Sea Alarm. AAL stands for “Action Alarm Level” and indicates the threshold that has to be exceeded before an action must be performed. BSAL stands for “Bottom Slamming Alarm Level” and shows the alarm level for bottom slamming. WRA stands for “Wave Response Amplitude” and shows the amplitude of the waves striking the hull. The 0-level for the amplitude is given by the waterline in still water. Historical data for the individual waves relative to the individual hull during a specific period of time constitute a “resultant wave diagram” as it appears based on actual loading condition, trim, speed and course and actual wave spectrum with the amplitudes of the waves as a function of time.

The tendency in the development in the “resultant wave diagram” is projected forward in time in a “wave response projection”. In this projection most importance is attached to the development in the amplitudes for the peak waves together with the last part of the historical period of time. Similarly, the projection will quickly adjust in step with changes in other variable parameters, such as speed, course, trim and ballast condition.

FIG. 7 illustrates a “resultant wave diagram” and a “wave response projection” only for wave crests and wave troughs (derived from the diagram in FIG. 6).

FIG. 8 illustrates a time lapse diagram (column I) and a projection (column II) for inclinations in both planes (fore-and-aft, indicated by LI, which stands for “Longitudinal Inclination” and thwartship, indicated by TI, which stands for “Transversal Inclination”) with alarm limits (AL stands for “Alarm Level” and AAL stands for “Action Alarm Level”). V indicates vertical inclination while H indicates horizontal inclination.

FIG. 9 illustrates a corresponding diagram and a projection for acceleration in both planes (vertical V and horizontal H) with alarm limits. G indicates the accelerations.

FIG. 10A illustrates the calculation of wave direction based on the difference in sensor values in series of measurements, i.e. the difference in average maximum is value of a series of individual waves measured in two pairs of sensor devices in the same longitudinal position in the hull on the starboard and port sides (FIG. 10A I). The said maximum values should be corrected for inclinations, accelerations (FIG. 8 and FIG. 9) and possibly also for the speed of the vessel and the waves before calculation of wave direction for increased accuracy. The difference in average values indicates wave direction. FIG. 10A illustrates how a change in wave direction from T1 to T2 increases the difference in the measurement values between the sensor on the starboard side and the sensor on the port side. Empirical material is used as a calibrating factor.

FIGS. 10A III and IV illustrate the wave response amplitude WRA on the port and starboard sides in relation to time. The difference in peak values can thereby be indicated in the last X minutes (where the user selects the time window) and the average difference in the last X minutes (where X is again selected by the user). The table in figure V shows the average angle for a series of waves.

FIG. 10B illustrates the calculation of wave direction based on average time difference (T) for detection of series of wave crests at two pairs of sensor devices S1 in the same longitudinal position (Stb 1/P1 and Stb 2/P2) on the hull on the starboard (Stb) and port sides. This is illustrated in greater detail in FIG. 10B I. The said maximum values are corrected for inclination and acceleration (FIG. 8 and FIG. 9). By correcting for the vessel's speed, the velocity of the waves will be obtained. The time difference can then be expressed in the distance travelled by the waves (m1 and m2) in this time interval (FIG. 10B III). In this figure sensors are shown placed on the forepeak and sensors placed on half-length. The exact distance between sensors in the same longitudinal position is known. The angle (a) of the waves relative to the vessel's longitudinal axis can be calculated. The table in FIG. 10B IV shows the average angle for a chosen number of waves.

FIG. 11 illustrates how the system can be used to calculate actual “sea state” (actual wave spectrum with wave period and amplitudes). In the same way as before, series of measurement values in two pairs of sensor devices in the same longitudinal position are evaluated. In the wave spectrum calculation the sensor with the lowest value in the sensor pair is employed (sensor devices with the same longitudinal position on the starboard and port sides), which at any time has the least difference in average values (the hull's own response has the least effect on the measurement data). After correcting for acceleration, inclination and the vessel's speed, the amplitudes of the individual waves can be calculated as a function of real time. From this calculation desired parameters can be calculated; maximum, minimum amplitudes, wave period and average for desired time interval. FIG. 11 I shows how average sensor values are obtained from series of measurements. FIG. 11 II illustrates adjustments for inclination and acceleration. FIG. 11 III illustrates average calculation for sensor values from one or more sets of sensors located at the same longitudinal and height position on each side of the hull, in the form of series of measurements. FIG. 11 IV illustrates the wave diagram adjusted for the vessel's speed, where the left-hand side shows the diagram without speed adjustment and the right-hand side with speed adjustment.

In conclusion and to sum up, we refer to FIG. 12, which illustrates an example of how a display presented in the presentation unit will appear to the user of the system.

On the upper left-hand side of the display can be seen a first area, ALARM STATUS, which will change colour, with green for OK, yellow for activated action alarm and red for alarm (for one or more measurement parameters in the system; “green sea”, bottom slamming, inclination, acceleration).

Below this area is a second area, WARNING STATUS, indicating various text messages associated with wave height sequence and early warning that an alarm may be triggered, including indication or specification of time for such alarms. Recommendations with regard to course and speed based on the state of the vessel and the sea may also be derived by the system and presented.

Below this is a third area, OPERATION, displaying operating parameters, e.g. speed, course and fuel consumption for main machinery. The parameters may, e.g., be given in real time (a) and, e.g., for one hour ago (b). The comparison between (a) and (b) will represent very useful information for providing optimal operation on board, both from the safety and economic points of view. By integrating expert system(s), it will be possible to give advice based on empirical data on optimal operational parameters under the prevailing weather conditions, as well as in the geographical area concerned (with, e.g., special wave spectra in bad weather).

The consequence of operational decisions (speed, course, ballast condition and trim) related both to fuel consumption in main machinery and to parameters related to “green sea”, bottom slamming, accelerations and inclinations is displayed below in a fourth area, STATUS. This displays graphically (may also be displayed numerically) the states related to “green sea”, bottom slamming, inclination and acceleration. Green—OK, yellow—action alarm and red area for alarm.

Up on the right is a fifth area, which displays WAVE DIRECTION relative to the vessel's longitudinal direction together with wave height on the vessel's hull. Both wave direction and height have been chosen to be displayed in the colours green, yellow and red related to alarm status.

This last figure illustrates clearly how a user can make use of the system according to the invention in a concrete application. The system is easy to use and gives signals in the form of colours as well as numbers, with the result that it is possible to obtain both a clear, rapid signal regarding the likelihood of the occurrence of a dangerous situation as well as an accurate indication or specification of the current values for the different variables.

On the bottom line in the display there is the option of retrieving more data for the various parameters. The option “OPERATOR GUIDANCE” or advice to the operator will offer advice on optimal operational decisions; speed, course, ballast condition and trim related to the risk of “green sea” on deck, bottom slamming, accelerations, inclinations and not least to fuel consumption for main machinery, which is of great economic importance. Advice to the operator is based on the use of expert systems and the empirical material concerning all parameters that will be available here for processing in the desired format. In order to build up such an empirical base at an early stage, a test diagram may be drawn up that is used for different wave spectra by varying the operational parameters. If so desired, the empirical material may also include geographical areas. This would enable the advice to also include special weather/wave conditions in relevant areas; e.g. exposed areas with shallow water, or where two currents meet, thus causing special wave spectra to build up in bad weather.

In the option “SIMULATION” on the bottom line, it will be possible to simulate the consequences of operational decisions by using the empirical material in integrated expert system(s).

In conclusion we shall present a summary of the meaning of system information from the various units:
Pressure sensors will be able to provide information directly concerning the height of the waves on the hull and issue a warning on the risk of “green sea”
Accelerometer will be able to provide information directly concerning the accelerations (2 axes) to which the hull is exposed with the operational parameters concerned
Inclinometer will be able to provide information directly concerning the ship's inclination (2 axes)
Vibrometers will be capable of being integrated in the system and providing information directly concerning vibrations as a result of bottom slamming or wave impact against the hull's bow or sides
Speedometer will provide information on the vessel's speed, thus allowing account to be taken of the influence of the speed on the load level and the possibility of load reduction by means of a change in speed
Course recorder will provide information on the influence of the course on the load level and the possibility of load reduction by means of a change of course
Position finder Information on the ship's position together with other stored information will enable loading diagrams to be recreated in specific geographical areas
Loading condition Information on the ship's loading condition together with other stored information will enable loading diagrams to be recreated at a later date in relation to loading condition
Trim and ballast Information on trim and ballast condition together with other stored information will enable loading diagrams to be recreated at a later date in relation to these parameters
Fuel consumption for main machinery Information on fuel consumption together with other for main machinery stored information will enable diagrams to be recreated for fuel consumption in the case of different parameters for economic optimisation
   Definitions
Hull-influenced or resultant waves: waves that are influenced by a vessel or the hull of an installation.
Resultant wave diagram: the curve traced by the waves on the side of the hull, with wave height in one axis and time in the other.
Resultant wave projection: assumed curve traced by the waves on the side of the hull.
Green sea: large quantities of water washing over the deck.
Bottom slamming: impact of waves on the bottom of the hull.
Online: as close to real time as electronics and data processing permit.
Sea state: significant wave height (possibly also direction).
Significant wave height: mean value of a third of the highest waves.
Amplitude: distance from the mean value to peak and trough.
Wave range: distance from peak to trough.
Wave spectrum: frequency content of the waves.

1. A data acquisition system for use on board a vessel or installation in order to provide basis data concerning waves that strike the vessel or installation to permit a survey of the individual wave's influence on the individual vessel or installation, characterised in that it comprises
at least one sensor device for mounting in/on the vessel's or the installation's hull, preferably in an area near the bow, arranged to provide a measuring signal associated with the presence of water at a given detection height on the outside of the hull,
a data processing unit arranged for storing and processing the measuring signals, and
signal transmission means for transmitting measuring signals to the data processing unit for storing and processing values for the measuring signals.

2. A data acquisition system according to claim 1, characterised in that it comprises
at least one sensor device on each side of the hull's bow, and/or
at least one sensor device on each side of the hull's half-length, and/or
at least one sensor device on each side of the hull's stern.

3. A data acquisition system according to claim 1, characterised in that it comprises at least two sensor devices mounted at different height positions on the same side of the hull.

4. A data acquisition system according to claim 1, characterised in that it comprises at least two sensor devices mounted at the same height position on the same side or on each side of the hull.

5. A data acquisition system according to one of the preceding claims, characterised in that
each sensor device comprises at least one pressure sensor, preferably mounted near the bottom of the hull and/or
each sensor device comprises several pressure sensors preferably mounted in the same longitudinal position, but preferably at different height positions on the same side of the hull and/or
each sensor device also preferably comprises a riser with flange and one valve per pressure sensor or another arrangement for purging and cleaning the system, a valve with flange, a sleeve device or grommet and an outer pipe with flange.

6. A data acquisition system according to one of the claims 1-5, characterised in that the sensor device(s) comprises pressure sensors of a standard make and/or of a special make, including but not restricted to electronic, ceramic, fibre optic or other types of pressure sensors and that the signal transmission means include but are not restricted to electric cables, fibre optic cables and radio link.

7. A data acquisition system according to claim 1, characterised in that it also comprises
one or more inclinometers and/or one or more accelerometers, these preferably measuring in several axes, for mounting in the vessel or installation, in order to provide static and/or dynamic data associated with the vessel's or the installation's roll, heave and accelerations, in addition to
input unit(s) for input of other measuring data such as measuring data related to the vessel's or the installation's speed, course, position, loading condition, trim as well as fuel consumption for the vessel's propulsion machinery.

8. A data acquisition system according to claim 1, characterised in that the data processing unit comprises means for:
a) processing the data from the sensor device(s) in order to provide wave spectra, hull-influenced and real wave spectra as a function of time,
b) recording data concerning the vessel's course, speed, loading condition, trim and position and processing thereof in order to provide the vessel's response profile regarding each individual wave as a function of time,
c) on the basis of the wave spectra provided in step a) together with the profile provided in step b), predicting the development of the wave spectra in time and/or the vessel's or the installation's condition as a consequence of this development,
d) providing limit values in the wave spectra as a function of the vessel's or the installation's capacitive load levels or, if regulations are introduced, permitted load levels,
e) on the basis of input data concerning capacitive and/or permitted limit values in the wave spectra corresponding to “green sea” on deck level and bottom slamming, providing limit values in the wave spectra together with alarm functions in the event of the limit value being exceeded,
f) on the basis of input data concerning capacitive and/or permitted limit values in the wave spectra, together with the data provided at a) and b) providing limit values for preventive actions; changing course and/or speed and/or ballast and/or trim, the limit values being adapted at all times to the vessel's or the installation's condition, the state of the wave spectrum and the predicted development,
g) storing the signals provided in steps a)-f) for subsequent processing and compilation of statistics.

9. A data acquisition system as indicated in claim 8, characterised in that the data processing unit further comprises means for:
manual or automatic calibration of the sensors in a sensor device, where the sensors are mounted in the same longitudinal position or in a position with the same hull design of the hull's side, where a sensor is calibrated by means of the measuring data from a second sensor mounted in a different height position in order to avoid wrong measurements from turbulence in the waves,
comparison of the measuring data from the various sensor devices and individual sensors and filtering in order to obtain a high degree of accuracy.

10. A data acquisition system as indicated in claim 8, characterised in that the data processing unit further comprises means for calculating wave direction relative to the vessel's longitudinal axis on the basis of:
comparison of output signals, maximum and/or minimum values for each wave or for series of waves, from sensors in sensor devices located in the same longitudinal and height position, but on opposite sides of the vessel or installation, where the signals are corrected for inclinations, possibly also for accelerations and possibly also the vessel's speed before the comparison, and/or
comparison of the time lapse of output signals, maximum and/or minimum values for each wave or series of waves, for the signals from sensors in sensor devices located in the same longitudinal and height position, but on opposite sides of the vessel or installation, in order to establish the time differences between registering maximum and/or minimum values for each wave or for series of waves, where the signals are corrected for inclinations, possibly also for accelerations and possibly also for the vessel's speed before the comparison, in order thereby to be able to calculate the relationship between the vessel's longitudinal direction and the wave front.

11. A data acquisition system as indicated in claim 1, characterised in that it comprises a presentation unit connected to the data processing unit for displaying the output signals from the data processing unit.

12. A data acquisition system according to claim 1, characterised in that the data processing unit comprises means for providing an accumulated data signal for further transmission through a fibre optic cable and/or an electric cable and/or via radio link and/or by some other means to one or more processing and presentation units.

13. A data acquisition system according to claim 11, characterised in that the presentation unit comprises means for displaying historical and continuously updated data for:
a) status: wave height, hull-influenced or not hull-influenced, in relation to “green sea” on deck and the bottom slamming threshold, inclinations, accelerations with their threshold levels together with wave direction,
b) the vessel's speed, course, position and fuel consumption of the vessel's propulsion machinery,
c) the vessel's/installation's loading, ballast and trim condition, the presentation unit being arranged to display the data in a), b) and c) as close to real time as the electronics and data processing permits, as well as in a diagram over time showing the values at least one hour back in time and/or a prediction of the values for a), b) and c) for a period of at least 5 minutes forward in time relative to the time of measurement.

14. A data acquisition system as indicated in claim 12, characterised in that the presentation unit is further arranged to display proposed limits for speed and course based on developments in the prevailing weather and wave conditions together with the vessel's loading, ballast and trim condition.

15. A data acquisition system as indicated in claim 14, characterised in that it comprises means for providing advice, where the said means include expert systems.

16. A data acquisition system as indicated in claim 1, characterised in that it comprises means for simulation of conditions related to the sea, operations and the vessel/installation, where the said means include expert systems.
